(19) United States
(12) Patent Application Publication
(10) Pub. No.: US 2026/0184242 A1
(43) Pub. Date: Jul. 2, 2026

(54) SEATBACK

(71) Applicants: TS TECH CO., LTD., Asaka-shi (JP); HONDA MOTOR CO., LTD., Tokyo (JP)

(72) Inventors: Hidetsune NONAKA, Shioya-gun (JP); Hiromi TANIGUCHI, Shioya-gun (JP); Kazuhiro MISHIBA, Shioya-gun (JP); Manabu MATSUMOTO, Wako-shi (JP)

(21) Appl. No.: 19/430,627

(22) Filed: Dec. 23, 2025

(30) Foreign Application Priority Data
Dec. 26, 2024 (JP) 2024-231140

(51) Int. Cl. B60N 2/56; B60N 2/68

(52) U.S. Cl. CPC B60N 2/565; B60N 2/68

(57) ABSTRACT

A seatback includes, a seatback frame including a pair of side frames and a cross member that is horizontally laid and rigidly joined between the pair of side frames; a cushion pad that is located on a front face side of the seatback frame and in which a surface is covered with a cover; and a blower located at a rear of the cushion pad. The blower is provided via a bracket on the cross member. An air outlet of the blower is located in a position that avoids the cross member. The bracket includes a protector that protects at least a part of the air outlet of the blower.

### CROSS-REFERENCE TO RELATED APPLICATION

This application is based upon and claims the benefit of priority from the prior Japanese Patent Application No. 2024-231140, filed on Dec. 26, 2024, the entire contents of which are incorporated herein by reference.

### BACKGROUND OF THE INVENTION

### Technical Field

The present disclosure relates to a seatback with a built-in blower for blowing air.

### Description of Related Art

Conventionally, there is a technology for fixing a blower to a seatback frame in a seatback with a built-in blower (e.g., Japanese Unexamined Patent Application Publication No. 2009-291310, International Publication No. 2017/002764).

In an invention of a vehicle seat described in JP 2009-291310, an upper part bracket (upper part frame) is arranged parallel to an upper frame of the seatback frame, and the blower is fixed in the center of the upper part bracket from a front of the seatback.

In the invention of the vehicle seat described in WO 2017/002764, a bracket and a cover member are fixed to a cross member that is horizontally laid attached to an upper part of the seatback frame by sandwiching the cross member from the front and back, and the blower is attached to this bracket by a bolt and nut. A duct with one opening connected to an opening provided in an inner pad of the seat and the other opening connected to an inlet of the blower is configured to be arranged in a vertical direction at the side of the blower.

In the invention of the vehicle seat of JP 2009-291310, a length of the blower in the vertical direction of the seat is larger than the vertical length of the upper part bracket (upper part frame), so an air outlet of the blower protrudes downward from a bottom edge of the upper part bracket. As a result, there is a problem that the air outlet is not adequately protected against a load from the rear of the seat and interference with other components. In addition, the air outlet may interfere with other components (e.g., harness) located around the blower.

In the invention of the vehicle seat of WO 2017/002764, the cover member is required in addition to the bracket for mounting the blower, because the bracket and the cover member are fixed to the cross member by sandwiching the cross member from the front and back. In addition, there is the problem that the configuration is complicated because the bracket and the cover member are joined by three sets of bolts and nuts, and the blower is attached to the bracket by three more sets of bolts and nuts. In addition, the duct is installed in the vertical direction on the side of the blower, and this causes the problem that the apparatus becomes larger in size.

### SUMMARY OF THE INVENTION

The present disclosure was made in view of the above problems, and the purpose of the present disclosure is to protect a blower and an air outlet in a seatback where the air outlet of the blower is located at a position avoiding a cross member.

Another object of the present disclosure is to enable a configuration including the blower built into the seatback and surrounding structures in a compact manner.

A further object of the present disclosure is to provide the seatback that can fix the blower to the seatback frame with a simple configuration.

To solve the above problem, according to an aspect of the present disclosure, a seatback includes:
a seatback frame including a pair of side frames and a cross member that is horizontally laid and rigidly joined between the pair of side frames;
a cushion pad that is located on a front face side of the seatback frame and in which a surface is covered with a cover; and
a blower located at a rear of the cushion pad,
wherein,
the blower is provided via a bracket on the cross member,
an air outlet of the blower is located in a position that avoids the cross member, and
the bracket includes a protector that protects at least a part of the air outlet of the blower.

According to another aspect, the seatback includes:
a seatback frame including a pair of side frames and an upper part frame that is horizontally laid and rigidly joined between upper ends of the pair of side frames,
a cushion pad that is located on a front face side of the seatback frame and in which a surface is covered with a cover; and
a blower located at a rear of the cushion pad,
wherein,
the blower is provided via a bracket on the upper part frame,
the air outlet of the blower is located lower than a bottom edge of the upper part frame, and
the bracket includes a protector that protects at least a part of the air outlet of the blower.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a front view showing an example configuration of an upper part of a seatback frame that is included in a seatback according to an embodiment of the present disclosure;

FIG. 2 is an exploded perspective view showing an example configuration of a blower provided in the seatback according to the present embodiment and a mounting bracket;

FIG. 3 is a perspective view of the blower and mounting bracket shown in FIG. 2 as one unit (blower unit);

FIG. 4 is a front view of the blower unit shown in FIG. 3 attached to the upper frame shown in FIG. 1;

FIG. 5 is a perspective view of an attached state of the blower unit shown in FIG. 4 viewed from the rear; and

FIG. 6A and FIG. 6B show a modification example of the present embodiment, FIG. 6A is a front view of another configuration of the mounting bracket for mounting the blower, and FIG. 6B is a side view thereof.

### DETAILED DESCRIPTION

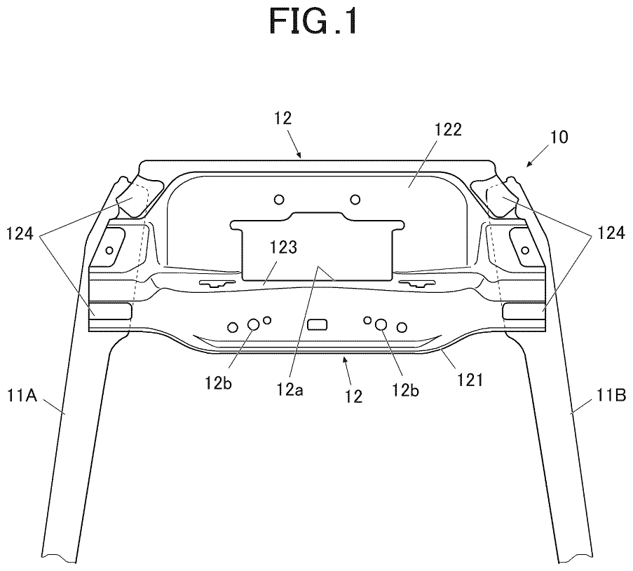

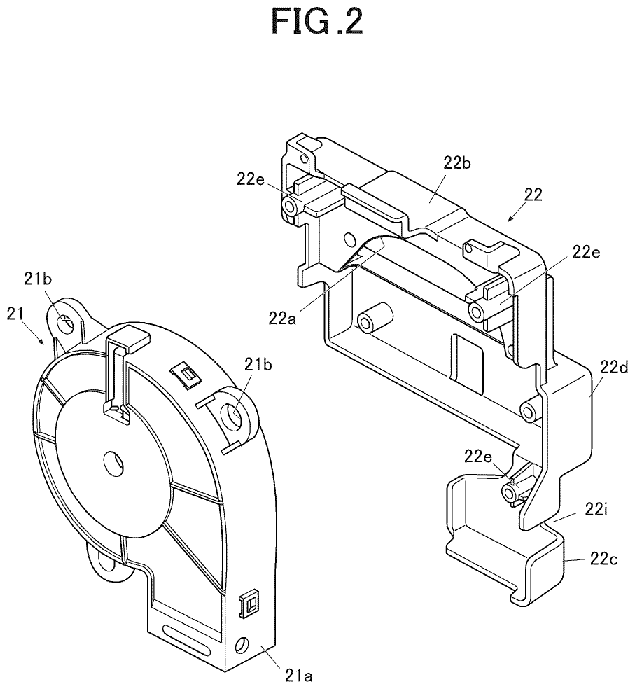

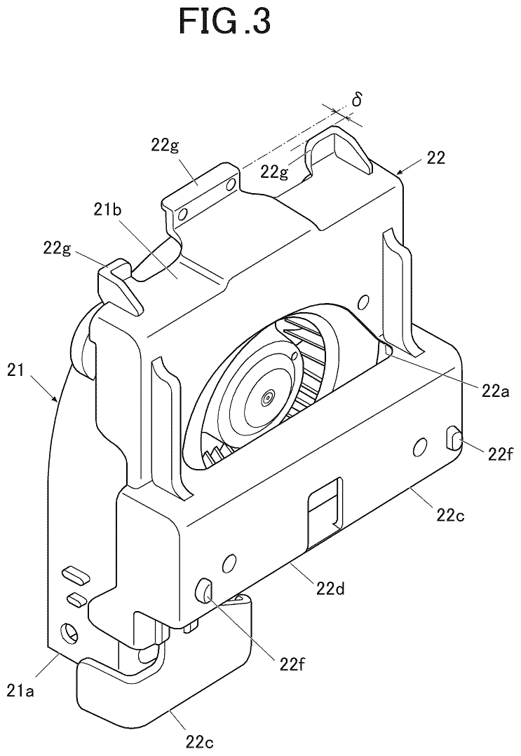

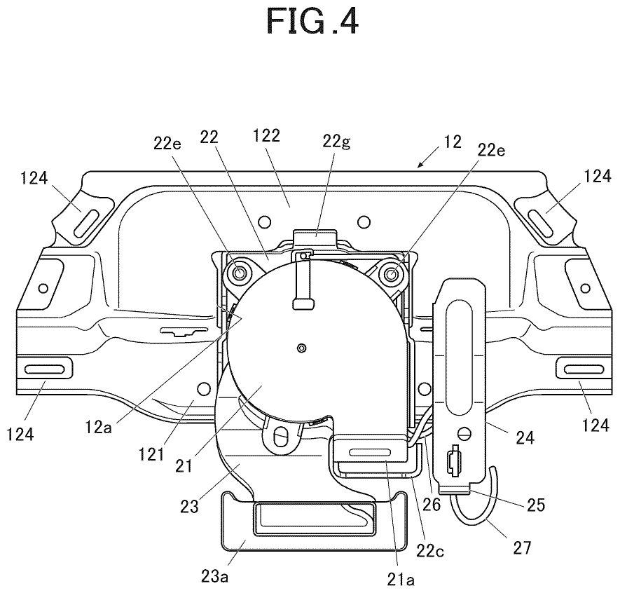

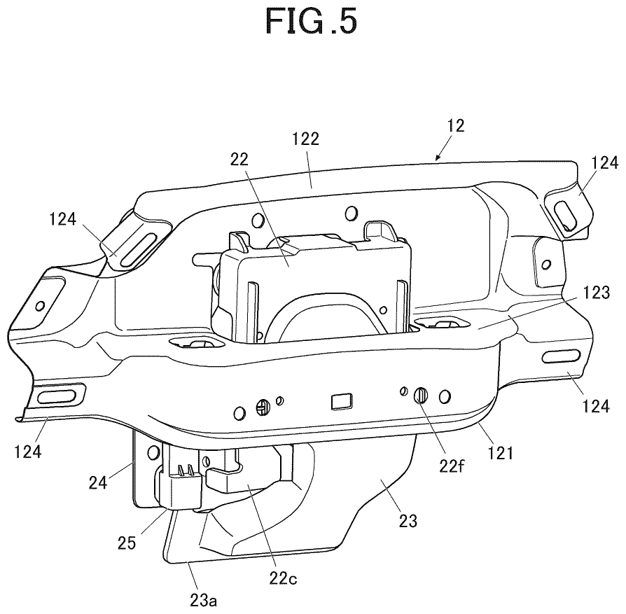

Embodiments of a seatback and a vehicle seat of the present disclosure are described below with reference to FIG. 1 to FIG. 5. Regarding the above, FIG. 1 is a front view of an upper frame provided in an upper part of a seatback frame which is to be a frame of a seatback, FIG. 2 is a perspective view showing an example configuration of a blower mounted to the upper frame shown in FIG. 1 and a mounting bracket, FIG. 3 is a perspective view showing a state in which the blower and the mounting bracket shown in FIG. 2 are combined, and FIG. 4 and FIG. 5 are a front view and an oblique view showing the state in which the blower is mounted on the upper frame via the mounting bracket. In the following description, unless otherwise mentioned, a travelling direction of a vehicle is referred to as forward (front) and the opposite direction is referred to as backward (rear).

As shown in FIG. 1, the seatback according to the present embodiment includes a seatback frame 10 that includes a pair of left and right side frames 11A and 11B, and a steel upper frame 12 provided in a width direction across upper ends of the side frames 11A and 11B, and that forms a substantial inverted U shape as viewed from a front-rear direction of the seat. The upper frame 12 and the side frames 11A and 11B are welded together to form a rigid joint state.

Although not illustrated, a lower frame is horizontally laid and rigidly joined between the lower ends of the above-described side frames 11A and 11B. On a front face side of the seatback frame 10, a cushion pad made of foam rubber or urethane foam and a pan frame that supports the cushion pad are provided, and a surface of the cushion pad is covered with a cover. The above-described upper frame 12 and lower frame serve as cross members of the seatback frame.

When the seatback according to the present embodiment is used in a vehicle seat, the lower end of the seatback frame 10 is connected to a rear end of the seat cushion frame, which serves as the frame of the seat cushion, in a tiltable manner via a hinge. A headrest is mounted on an upper part of the seatback frame 10.

The side frames 11A and 11B, which form the frame of the seatback, may consist of an inner side frame and an outer side frame, or may be made of a pipe or pan frame.

The upper frame 12 according to the present embodiment includes a base portion 121 of a lower part and a protruding surface portion 122 protruding forward than the base portion 121, and is provided with an opening part 12a for inserting the blower and bracket described below. Between the base portion 121 and the protruding surface portion 122, there is a horizontal piece portion 123. Such horizontal piece portion 123 is also provided with an opening part, so that the opening part 12a forms an L-shape viewed from the side from the base portion 121 to the protruding surface portion 122. As described above, the protruding surface portion 122 includes a shape protruding forward than the base portion 121, and the opening part 12a is formed from the base portion 121 to the protruding surface portion 122 to form a storage recess portion in which the blower can be stored.

Both sides of the above upper frame 12 are provided with joining surface portions 124 that are joined and adhered to the side frames 11A and 11B.

Furthermore, the base portion 121 of the upper frame 12 is provided with two engagement holes 12b for coupling a bracket 22 to the upper frame 12 by engaging the bosses provided on the blower mounting bracket 22.

FIG. 2 shows a specific example of a blower 21 and a mounting bracket 22. As shown in FIG. 2, the upper part of the bracket 22 is provided with a fitting portion 22b including an opening 22a into which the upper part of the blower 21 is fitted on the front face side. The blower 21 is fitted in this fitting portion 22b in a state in which the air outlet 21a is facing downward. The lower part of the bracket 22 is provided with a protective section 22c (protector) to protect part of the air outlet 21a of the blower 21. Specifically, a cutout is provided in a horizontal piece of the protective section 22c opposite the air outlet 21a to protect two of the four edges of the air outlet 21a, which is rectangular in shape. The cutout may be provided in the horizontal piece of the protective section 22c opposite the air outlet 21a so as to protect two of the four edges of the air outlet 21a.

At a middle position of the bracket 22 in a height direction, a rearward protruding portion 22d is provided, and the above-described opening 22a is formed from the fitting portion 22b to the protruding portion 22d. With this, an L-shape is formed viewed from the side.

The opening 22a is also provided in the protruding portion 22d so as to be able to store and place a duct (later-described) which is connected to an inlet of the blower 21.

In addition, at a position higher than the lower end of the air outlet 21a in the above-described protective section 22c of the bracket 22, an opening part 22i is provided for passing a harness through (see FIG. 2). This can prevent the harness from interfering with a projection portion of the air outlet when the harness moves in a vertical direction of the seat.

In addition, two boss sections 22e are formed at a predetermined location on the front face of the bracket 22 that engage two engagement holes 21b provided in the case of the blower 21. Therefore, by bringing the blower 21 closer to the front face of the bracket 22 so as to fit the upper part of the blower 21 into the opening 22a of the bracket 22, and engaging the engagement hole 21b of the blower 21 with the boss section 22e of the bracket 22, the blower 21 and bracket 22 can be integrated as one, as shown in FIG. 3.

The above engagement holes 21b and the boss sections 22e that engage with the engagement holes 21b are not limited to two, but may be three or more each.

On the other hand, a rear face of the protruding portion 22d is provided with a pair of boss sections 22f for coupling the bracket 22 to the upper frame 12 by engaging the bracket 22 with the engagement holes 12b of the upper frame 12, as shown in FIG. 3. In FIG. 3, the duct is not connected to the blower 21.

In addition, three upwardly protruding ribs or claw-shaped latching pieces 22g are formed on a front edge of an upper wall of the fitting portion 22b of the bracket 22. The center one and the two left and right pieces of these three latching pieces 22g are formed so that they are aligned in a substantial straight line with an interval δ that allows insertion of a flat plate with a thickness of several millimeters, as viewed from above.

In the seatback according to the present embodiment, the blower 21 and bracket 22 are integrated as shown in FIG. 3, and one (upper side) opening of a duct 23 (see FIG. 4) (hereinafter referred to as the blower unit) is connected to the inlet of the blower 21, which is attached to the upper frame 12 in FIG. 1. Here, the above three latching pieces 22g provided on the upper part of the bracket 22 are engaged with the upper side edge of the opening part 12a of the upper frame 12.

As a result, the upper part of the bracket 22 is latched to the protruding surface portion 122 of the upper frame 12, so that the upper side edge of the opening part 12a is sandwiched at the front and rear by the one latching piece 22g in the center and the two latching pieces 22g at the left and the right.

The pair of boss sections 22f on the rear face of the bracket 22 are engaged with the engagement holes 12b provided in the upper frame 12.

This allows the blower unit to be mounted on the upper part of the seatback frame 10 with the blower unit positioned in the opening part 12a of the upper frame 12, as shown in FIG. 4. Therefore, since the blower 21 is arranged via the bracket 22 in the storage recess portion provided in the upper frame 12 of the seatback frame 10, a main body of the blower 21 can be protected by the bracket 22 and the blower 21 can be fixed to the seatback frame 10 with a simple configuration. Since the opening part 12a is provided in the upper frame 12 and the storage recess portion is formed including the opening part 12a, the upper frame 12 including the storage recess portion can be made compact.

The other (lower side) opening of the duct 23 is connected to a correspondingly sized opening that is formed in a lumbar support that supports the rear face of the cushion pad of the seatback, or in a sheet that covers the rear face of the cushion pad (not shown). Therefore, the blower unit consisting of the blower, the bracket, and the duct can be compactly configured because the duct does not jump out to the rear of the upper part frame.

When the blower 21 is powered and a fan is rotated, the air in the space in the rear part of the seatback or the pad is sucked in, reducing the humidity and temperature on the back side of the person seated in the seat, thereby improving comfort.

The duct 23 is made of a material having moderate flexibility, and the lower side opening of the duct 23 is positioned to face forward. The edge of such opening is provided with a flange section 23a to prevent air leakage. As described above, the duct 23 is arranged in the vertical direction and is provided with a flange section 23a at the lower side opening edge. The air outlet 21a of the blower 21 is arranged so that it is located within the width of the flange section 23a in a seat width direction. This allows the air outlet 21a of the blower to be provided in a state close to the duct 23. With this, the blower unit, which consists of the blower, the bracket and the duct, can be compactly configured.

According to the present embodiment, the blower 21 is arranged so that the air outlet 21a faces downward and so that the air outlet 21a is in a position biased to the right direction from the center line of the seat, and the duct 23 is arranged in the vertical direction in a position toward the center side of the seat than the air outlet 21a of the blower 21. This allows the duct to be located in the center of the seatback, along the centerline, in a vertical direction.

Furthermore, as shown in FIG. 4 and FIG. 5, according to the present embodiment, the upper end of a strip-shaped mounting plate 24 is adhered to one side (left side in the figure) of the front face of the protruding surface portion 122 of the upper frame 12. Here, the protruding surface portion 122 is located to the front than the base portion 121. Therefore, the mounting plate 24, the upper end of which is adhered to the front face of the protruding surface portion 122, hangs down from the protruding surface portion 122. As a result, the lower part of the mounting plate 24 is farther to the front from the base portion 121 and protrudes lower than the lower edge of the upper frame 12, providing more room in the space.

Therefore, using the above space, a connector 25, which serves as a socket (or plug), is attached to the lower rear face of the mounting plate 24. Specifically, a hole is formed in the lower end of the mounting plate 24 for fastening the connector 25, and the connector 25 is fastened to the mounting plate 24 by inserting a fastening portion (projection) of the connector 25 into this hole. An end of the wire (lead wire) 26 drawn from the blower 21 is connected to this connector 25. The connector 25 is plugged into a connector that serves as a plug (or socket) provided at the end of a power supply harness 27 located in the rear part of the seatback to enable power supply.

As described above, by providing the mounting plate 24 on the upper frame 12 and attaching the connector 25, the harness for power supply can be secured by the connector. This can make contact failures less likely to occur compared to when the harness is in a movable state. In addition, the connector 25 for connection is provided on the mounting plate 24 fixed to the upper frame 12, so that the entire blower unit, which is placed in the opening part of the upper frame 12, can be made compact.

Furthermore, the air outlet 21a of the blower 21 is located lower than the lower edge of the upper frame 12 and the lower end side opening of the duct 23 is located lower than the air outlet 21a of the blower 21. With this, it becomes more easy to perform the process of the connection of the lower end side opening of the duct 23 to the opening part of the sheet or panel covering the rear face of the pad of the seatback.

As shown in FIG. 4, the blower 21 is arranged so that the air outlet 21a faces downward and so that the air outlet 21a is in a position biased to the right direction from the center line of the seat. With this, the lower end side opening of the duct 23 can be positioned in the center of the upper frame 12 in the seat width direction, that is, the center of the seatback width direction. Therefore, air can be sucked in from the rear face of the seatback in a well-balanced manner without being biased to either the right or the left. The protective section 22c of the bracket 22 is positioned opposite the air outlet 21a of the blower 21 in a spaced apart state. Thus, the protective section 22c is positioned opposite the air outlet 21a of the blower 21 in a spaced apart state, so that the protective section 22c can be formed in a size to protect the four edges of the air outlet 21a.

Furthermore, although it is conceivable to arrange the blower 21 in a state in which the air outlet 21a faces sideways, in this embodiment, the blower 21 is fitted into the fitting portion 22b of the bracket 22 with the air outlet 21a facing downwards, so that the duct 23 can be arranged next to the air outlet 21a, parallel to the air outlet 21a. Therefore, the width of the blower unit can be reduced, thereby making the blower unit more compact.

### Modification Example

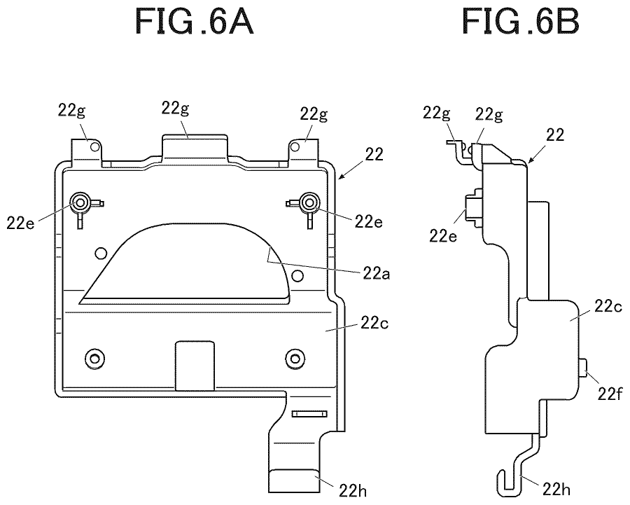

FIG. 6A and FIG. 6B show modification examples of the above embodiments.

This modification example is provided with a hook-shaped latching section 22h that engages to the edge of the air outlet 21a of the blower 21, instead of providing a protective section 22c, on the lower end of the bracket 22 that constitutes the blower unit. This configuration can suppress rattling of the blower 21. According to the shape shown in the drawing, the configuration also functions to partially protect the edge of the air outlet 21a of the blower 21.

The three upward-facing latching pieces 22g provided on the upper end of the bracket 22 include hemispherical projections formed on the surface in contact with the edge of the opening part 12a of the upper part frame 12. This allows the upper end of the bracket 22 to be more firmly latched to the upper part frame 12.

Although one embodiment of the present disclosure has been described above, the invention is not limited to the aforementioned embodiments and can be implemented with various changes without departing from the scope of the essentials of the embodiments. For example, in the above embodiment, an upper frame 12 is provided between the upper ends of the side frames 11A and 11B, but a cross member in the lower vicinity of the upper frame 12 or a reinforcement plate with both sides adhered to the side frames 11A and 11B to cover the rear part of the upper frame 12 may be provided. Since the upper frame 12 of the above embodiment includes a complex shape with irregularities, it is difficult to process if a plate with a thick thickness is used. However, there is a risk of insufficient strength if the plate thickness is thin because of the opening part 12a. By providing a reinforcement plate or cross member, the risk of insufficient strength of the upper part of the seatback frame can be avoided. The reinforcement plate should be shaped to include a rearward bulging recess to avoid interference with the blower unit.

In the above embodiment, a protective section 22c is provided on the bracket 22 to protect the edges of two sides of the air outlet 21a of the blower 21. However, instead of the cutout, a rectangular opening corresponding to the opening of the air outlet 21a can be provided on the protective section 22c to protect the edges on all four sides of the air outlet 21a.

Furthermore, in the above embodiment, the seatback of the present disclosure is described as applied to a vehicle seat as an example. However, the present disclosure is not limited to vehicle seats, but can also be applied to seats for ships, aircrafts, and other vehicles, as well as seats (sofas) as furniture.

A seatback includes: a seatback frame including a pair of side frames and a cross member that is horizontally laid and rigidly joined between the pair of side frames; a cushion pad that is located on a front face side of the seatback frame and in which a surface is covered with a cover; and a blower located at a rear of the cushion pad, wherein, the blower is provided via a bracket on the cross member, an air outlet of the blower is located in a position that avoids the cross member, and the bracket includes a protector that protects at least a part of the air outlet of the blower.

According to the embodiment described above, the blower is installed via the bracket on the cross member of the seatback frame, and the bracket includes the protective section that protects the air outlet of the blower. Therefore, even if the air outlet is located lower than the lower end of the upper part frame, it is possible to protect the main body of the blower and the air outlet.

A seatback includes: a seatback frame including a pair of side frames and an upper part frame that is horizontally laid and rigidly joined between upper ends of the pair of side frames, a cushion pad that is located on a front face side of the seatback frame and in which a surface is covered with a cover; and a blower located at a rear of the cushion pad, wherein, the blower is provided via a bracket on the upper part frame, the air outlet of the blower is located lower than a bottom edge of the upper part frame, and the bracket includes a protector that protects at least a part of the air outlet of the blower.

According to the embodiment described above, the blower is installed via the bracket on the upper part frame of the seatback frame, and the bracket includes the protective section that protects the air outlet of the blower. Therefore, even if the air outlet is located in a position avoiding the cross member, it is possible to protect the main body of the blower and the air outlet.

According to the above-described seatback, the protector is provided in a position opposite the air outlet of the blower.

According to the embodiment described above, the edge of the air outlet of the blower can be protected.

According to the above-described seatback, the air outlet of the blower is provided facing downward, and the protector includes a horizontal piece opposite the air outlet of the blower, and a cutout is provided in the horizontal piece.

According to the embodiment described above, the edge of the air outlet of the blower can be protected.

According to the above-described seatback, the protector is formed opposite of a rear end of the air outlet of the blower and an outer side part of the seatback frame in a width direction.

According to the embodiment described above, the edge of the air outlet of the blower can be protected.

The above-described seatback further includes a duct in which one end is connected to the blower, wherein, the duct is arranged in a vertical direction, and the protector is located between the duct and the air outlet in a width direction of the seatback frame.

According to the embodiment described above, it is possible to prevent the duct of the blower from interfering with the projection portion of the outlet when the duct moves in the seat width direction.

The above-described seatback further includes a duct in which one end is connected to the blower, wherein, the duct is arranged in a vertical direction, and the protector is located between an opening of the other end of the duct and the air outlet in the vertical direction of the seatback frame.

According to the embodiment described above, it is possible to prevent the duct of the blower from interfering with the projection portion of the outlet when the duct moves.

According to the above-described seatback, the protector includes an opening part through which a harness is passed, and the opening part is positioned above a lower end of the air outlet.

According to the embodiment described above, it is possible to prevent the harness from interfering with the projection portion of the air outlet when the harness moves in the vertical direction of the seat.

Although some embodiments of the present disclosure have been described and illustrated in detail, the disclosed embodiments are made for purposes of not limitation but illustration and example only. The scope of the present disclosure should be interpreted by terms of the appended claims.

1. A seatback comprising:
a seatback frame including a pair of side frames and a cross member that is horizontally laid and rigidly joined between the pair of side frames;
a cushion pad that is located on a front face side of the seatback frame and in which a surface is covered with a cover; and
a blower located at a rear of the cushion pad,
wherein,
the blower is provided via a bracket on the cross member,
an air outlet of the blower is located in a position that avoids the cross member, and
the bracket includes a protector that protects at least a part of the air outlet of the blower.

2. A seatback comprising:
a seatback frame including a pair of side frames and an upper part frame that is horizontally laid and rigidly joined between upper ends of the pair of side frames,
a cushion pad that is located on a front face side of the seatback frame and in which a surface is covered with a cover; and
a blower located at a rear of the cushion pad,
wherein,
the blower is provided via a bracket on the upper part frame,
the air outlet of the blower is located lower than a bottom edge of the upper part frame, and
the bracket includes a protector that protects at least a part of the air outlet of the blower.

3. The seatback according to claim 2, wherein the protector is provided in a position opposite the air outlet of the blower.

4. The seatback according to claim 2, wherein,
the air outlet of the blower is provided facing downward, and
the protector includes a horizontal piece opposite the air outlet of the blower, and a cutout is provided in the horizontal piece.

5. The seatback according to claim 2, wherein the protector is formed opposite of a rear end of the air outlet of the blower and an outer side part of the seatback frame in a width direction.

6. The seatback according to claim 2,
further comprising a duct in which one end is connected to the blower,
wherein,
the duct is arranged in a vertical direction, and
the protector is located between the duct and the air outlet in a width direction of the seatback frame.

7. The seatback according to claim 2,
further comprising a duct in which one end is connected to the blower,
wherein,
the duct is arranged in a vertical direction, and
the protector is located between an opening of the other end of the duct and the air outlet in the vertical direction of the seatback frame.

8. The seatback according to claim 2, wherein,
the protector includes an opening part through which a harness is passed, and
the opening part is positioned above a lower end of the air outlet.

9. The seatback according to claim 1, wherein the cross member is an upper part frame that is horizontally laid and rigidly joined between upper ends of the pair of side frames, and the position that avoids the cross member is the position lower than a lower end of the upper part frame.
